(19) United States
(12) Patent Application Publication
(10) Pub. No.: US 2013/0167708 A1
(43) Pub. Date: Jul. 4, 2013

(54) ANALYZING AUDIO INPUT FROM PERIPHERAL DEVICES TO DISCERN MUSICAL NOTES

(71) Applicant: Disney Enterprises, Inc., Burbank, CA (US)

(72) Inventor: Armen Mkrtchyan, Glendale, CA (US)

(73) Assignee: DISNEY ENTERPRISES, INC., Burbank, CA (US)

(21) Appl. No.: 13/726,775

(22) Filed: Dec. 26, 2012

Related U.S. Application Data
(60) Provisional application No. 61/581,084, filed on Dec. 28, 2011.

(51) Int. Cl. G10H 7/00

(52) U.S. Cl. CPC G10H 7/00
USPC 84/603

(57) ABSTRACT

One aspect provides a method, including: receiving an analog note unit at an information handling device; storing note unit information corresponding to the analog note unit in a memory device of the information handling device; identifying the analog note unit input using the note unit information; and providing a result output to a user responsive to identifying the analog note unit. Other aspects are described and claimed.

### CLAIM FOR PRIORITY

This application claims priority to U.S. Provisional Patent Application Ser. No. 61/581,084, entitled “ANALYZING AUDIO INPUT FROM PERIPHERAL DEVICES TO DISCERN MUSICAL NOTES”, filed on Dec. 28, 2011, the contents of which are incorporated by reference in their entirety herein.

### BACKGROUND

Many devices have been developed to analyze music in some fashion. Such devices include electronic devices that provide training and feedback to users. Examples of such devices include electronic applications that play music and prompt users to repeat the played music or identify the note(s) making up the musical sound. An example of such an application is the KARAJAN music and ear trainer application. Many games also incorporate music analysis at some level. For example, the GUITAR HERO video game (and like video games) challenge users to provide proper inputs corresponding to music, which are scored as part of the game. Other applications have been geared to analyze music for the purpose of identifying songs, such as the SHAZAM audio application, which identifies songs based on audio fingerprinting of song segments.

Conventionally, applications for musical training and gaming devices are limited to proprietary inputs means (e.g., proprietary input devices used with a game console) or to handling digital audio formats. This limits these devices to use with specific hardware or on-device analysis of digital audio formats. Song identification applications tend to be limited to somewhat lengthy music segments and are essentially employed only to identify captured audio.

### BRIEF SUMMARY

One aspect provides a method, comprising: receiving an analog note unit at an information handling device; storing note unit information corresponding to the analog note unit in a memory device of the information handling device; identifying the analog note unit input using the note unit information; and providing a result output to a user responsive to identifying the analog note unit.

Another aspect provides a system comprising: one or more processors; and a memory operatively coupled to the one or more processors that stores instructions executable by the one or more processors to perform acts comprising: receiving an analog note unit; storing note unit information corresponding to the analog note unit; identifying the analog note unit input using the note unit information; and providing a result output to a user responsive to identifying the analog note unit.

A further aspect provides a program product, comprising: a storage medium having computer program code embodied therewith, the computer program code comprising: computer program code configured to receive an analog note unit input to an information handling device; computer program code configured to store note unit information corresponding to the analog note unit in a memory device of the information handling device; computer program code configured to identify the analog note unit input using the note unit information; and computer program code configured to provide a result output to a user responsive to identifying the analog note unit.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of capturing and analyzing audio input to discern musical notes.

FIG. 2 illustrates an example of analyzing audio input to discern musical notes.

FIG. 3 illustrates an example information handling device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well-known structures, materials, or operations are not shown or described in detail to avoid obfuscation. The following description is intended only by way of example, and simply illustrates certain example embodiments.

Embodiments provide for analyzing ambient audio in the form of an analog note unit. An analog note unit is defined herein as a discrete analog audio waveform. The discrete analog audio waveform may include one note or a plurality of notes (i.e., in the case of a chord). In the case of more than one note per note unit, the notes are produced such that a discrete waveform is produced.

The analog note unit may be produced by a musical instrument or other peripheral device (electronic music synthesizer) and captured by an audio input device (e.g., microphone), or may be directly connected to the capturing device (e.g., via in-line audio jack such as a standard 3 mm audio jack). An embodiment provides for creating note unit information (e.g., information characterizing the analog note, such as frequency information corresponding to the analog waveform) for analyzing note unit(s), for example as received from peripheral musical instrument(s) or peripheral device(s). The note unit information may be used by embodiments to identify note(s) of the note unit or note units and provide output in response thereto. For example, an embodiment may provide output in the form of transcription of the note(s) of the note unit, in the form of corrective feedback or scoring, or a suitable combination of the foregoing. Moreover, an embodiment may receive, analyze and provide output regarding a series of note units.

An embodiment analyzes a musical note unit to identify it. The identification may proceed in real time or near real time (i.e., on a per-note unit basis). Once the musical note unit received is identified, an embodiment may provide a variety of outputs. The outputs may be provided in real time or near real time (i.e., on a per-note unit basis). The outputs may include but are not limited to transcribing the note unit received (i.e., transcribing the note or notes making up the note unit) and scoring based on the note unit(s) received (i.e., scoring on the basis of a comparison of the received note unit(s) with expected note unit(s)).

Embodiments analyze analog audio (ambient audio such as audio provided through an audio channel (e.g., 3 mm audio jack)). Thus, embodiments are not tied to particular proprietary peripheral devices and are not limited to analysis of digital audio formats. Embodiments therefore provide systems and associated methods for detecting and analyzing audio input as received by “computing” devices, also referred to herein as information handling devices. Examples of mobile computing devices or information handling devices include but are not limited to hand held information handling devices, such as smart phones, tablet/slate computing devices, portable media players/digital audio players (for example, MP3 music players), portable gaming devices, game consoles, but may also include more conventional “computing” devices, such as clamshell style lap top computers or desktop computers. Thus, embodiments may in some cases also be implemented (in whole or in part) on non-mobile computing devices such as a desktop computing device. In this description, the terms “information handling device”, “device”, “computer” and the like are utilized as shorthand for any device that includes the appropriate circuitry and components to provide the referenced functionality described.

Embodiments may employ peripheral devices or components, such as an integrated microphone on a smart phone, to capture ambient audio, for example produced by a musical instrument, such as a guitar, or produced electronically, such as an electronic device that produces the notes of a guitar as audible output (e.g., to a speaker or to an audio jack). Once an analog audio sample has been obtained, an embodiment may analyze it against a known reference audio sample or samples (“note unit information”). The analysis may include a variety of techniques, such as comparing the frequencies of the captured audio sample with one or more reference audio samples. An embodiment may provide an output responsive to the analysis, for example reporting a match between the captured audio and the reference audio, or transcribing the note or notes contained in the note unit received and identified.

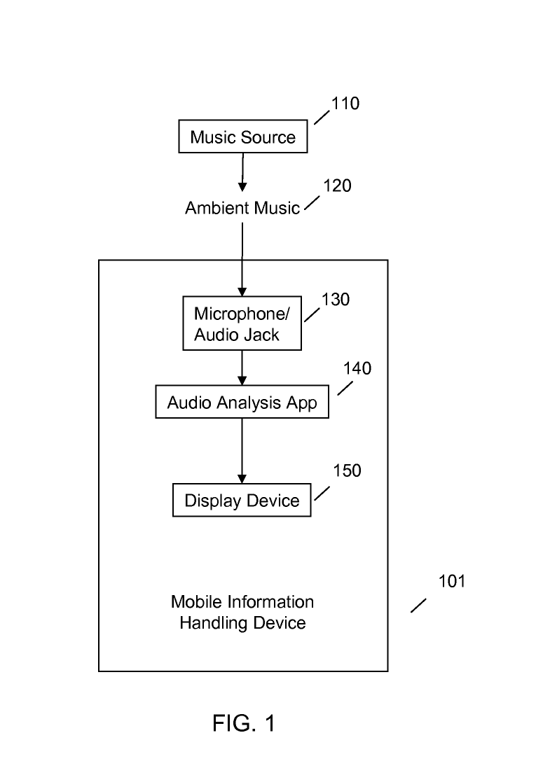

Referring to FIG. 1, an embodiment provides for detecting and analyzing audio input on mobile computing/information handling device. For example, a music source 110, such as a guitar, piano, peripheral device or the like provides detectable analog note unit(s) (“music”) 120. An embodiment may be implemented on a mobile information handling device 101, such as a smart phone, and utilize a peripheral device, such as an integrated microphone 130, to capture ambient music 120 produced by a musical source/instrument 110. The ambient music 120 in the form of a note unit also may be input to/received by the information handling device 101 via an audio jack. Once an ambient music 120 sample in the form of a note unit is saved or stored into memory, which may include caching note unit information in a temporary or intermittent fashion in a memory device, an embodiment may analyze it against a known reference audio sample.

The analysis may be by way of a software application 140 (“software app”) that is downloaded and installed on mobile information handling device 101. The analysis may include comparing characteristics (e.g., the frequency) of the captured audio sample with one or more reference audio samples. The analysis comprises identifying the discrete waveform included in the captured audio, i.e., the note unit. This may be done by identifying beginning and end points of the note unit, as well as other characteristics of the note unit (e.g., pitch (frequency, period) and amplitude). The characteristics of the note unit may then be analyzed and compared to stored note unit characteristic(s) to provide an output result.

An embodiment may provide an output responsive to the analysis. For example, an embodiment may report a match between the captured note unit and a reference or expected note unit representing a known musical note of a given instrument by providing an appropriate output to a display device 150. For example, this output may take the form of transcribing the musical note for the user responsive to a match. Thus, an embodiment may match the received note unit to a stock note unit and transcribe it, as if the user had written down the musical note(s) of the note unit on a sheet of music. Thus, an embodiment may transcribe the note (or notes, in the case of a chord) for the note unit received. This output may be provided in real time or near real time, i.e., on a per-note unit basis. Accordingly, a user providing a series of musical notes to an embodiment may have the notes transcribed automatically on a rolling basis. The notes transcribed may be displayed, e.g., on a display device 140 of an information handling device 101, such that a user may watch the notes transcribed as they are played. The transcribed notes may be stored for later reference.

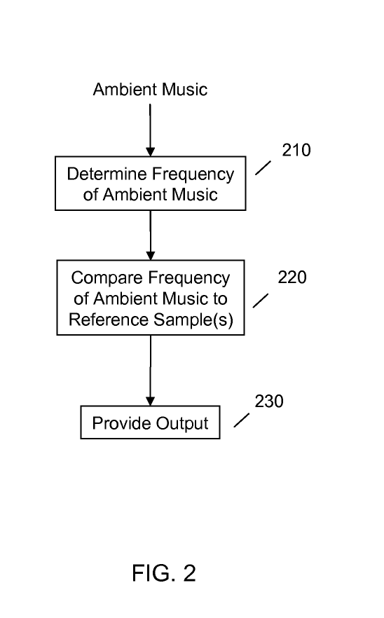

The analysis provided by an embodiment may include comparing frequencies of ambient music captured by a mobile information handling device 101 to expected (stored) musical notes. Referring to FIG. 2, an embodiment may first determine the frequency of the analog note unit captured at 210. This may involve recording ambient sound using a microphone of the information handling device 101 or receiving audio input via an audio jack of the information handling device 101. Once a sample is recorded, an embodiment may perform signal processing to convert the ambient audio sample into a usable sample for frequency comparison. A variety of techniques may be employed in this regard, and may include techniques for reducing noise in the captured sample, conversion of raw recording sample data to digital comparison data, and the like.

Once an embodiment has prepared a sample of captured ambient music for comparison (i.e., produced note unit information corresponding to the captured note unit), one or more reference samples may be accessed and used for comparison 220. In this regard, an embodiment may compare the captured and reference samples by comparing the frequencies of the samples to determine a match. The frequency of a musical note produced by a particular instrument is known and may be ascertained in advance. Once a captured sample is obtained by an embodiment, its frequency may be compared against such a reference frequency to determine if there is a match (for example, to some degree of confidence). As described, the match may be on a note unit-per-note unit basis, or the match may be in series (e.g., an expected string or series of note units may be matched to the received note units). Thus, an embodiment may be utilized by a user to compare a musical note unit (or series of musical note units) played on an instrument to a reference. In this way a user may determine the degree to which the user is accurately reproducing an expected musical note unit (or series of musical note units).

An embodiment identifies musical note unit(s) received by comparing them to reference musical note unit(s) stored in the analysis application. Such comparison may be used to provide the user with useful feedback, such as scoring the input received on the basis of comparison of the expected input. This may comprise scoring individual notes of the received input, or an overall scoring of the received notes in a series. Moreover, this scoring may include a comparison of the expected relationship between the note units, e.g., their relative spacing in time with respect to one another (in the case of a series of note units), the relative amplitude of the note units (e.g., received versus expected), or a combination of the foregoing comparisons.

Responsive to such an analysis, an embodiment may provide an output 230 reporting the result of the analysis. For example, an embodiment may provide a visual display of the result for the user's review. An embodiment may provide a running report (animation) of results, such as a continuous or near real-time analysis of the music being analyzed, such that a user may have real-time feedback for practice. An embodiment may provide visual feedback in the form of a screen signal or a dedicated light, e.g., showing whether the expected note was hit at the expected time. An embodiment may provide additional or other outputs, such as audio outputs.

Accordingly, an embodiment captures input analog note unit(s), identifies the input note unit(s) by comparison to reference(s) (such as via frequency comparison), and provides output. The output may take a variety of forms, such as transcribing the note(s) of the note unit(s), comparing and/or scoring based on expected note unit(s), or a combination of the foregoing. By utilizing analog note units, an embodiment achieves a flexibility in that no proprietary hardware is necessary, as analog audio input is used for comparison.

An embodiment may be provided as a downloadable application that, once installed on an appropriately equipped information handling device or computer, provides the functionality described herein. Moreover, embodiments may be implemented as a system, method, apparatus or computer program product. Accordingly, various embodiments may take the form of an entirely hardware embodiment, an entirely software embodiment (including firmware, resident software, micro-code, et cetera) or an embodiment combining software and hardware aspects. Furthermore, embodiments may take the form of a program product embodied in one or more device/computer readable storage medium(s) having program code embodied therewith.

Any combination of one or more device/computer readable storage medium(s) may be utilized. A storage medium in this regard may be, for example, but not limited to, an electronic, magnetic, optical, electromagnetic, infrared, or semiconductor system, apparatus, or device, or any suitable combination of the foregoing. A device/computer readable storage medium in the context of this document may be any non-signal medium that can contain or store a program for use by or in connection with an instruction execution system, apparatus, or device.

Program code for carrying out operations of various embodiments may be written in any combination of one or more programming languages (including an object oriented programming language such as Java™, Smalltalk, C++, Objective-C, or the like and conventional procedural programming languages, such as the “C” programming language or similar programming languages). The program code may execute entirely on the user's device, partly on the user's device, as a stand-alone software package, partly on the user's device and partly on a remote device, or entirely on a remote device or server. The remote device may be connected to the user's device through any type of network, including a local area network (LAN) or a wide area network (WAN), wireless networks such as WMAN or WWAN networks, or any suitable network connection.

It will be understood that certain embodiments can be implemented by an information handling device such as a mobile computing device executing a program of instructions. These program instructions may be provided to a processor of a device to produce a machine, such that the instructions, which execute via the processor of the device implement the functions/acts specified.

These program instructions may also be stored in a device/computer readable medium that can direct a device to function in a particular manner, such that the instructions stored in the medium produce an article of manufacture including instructions which implement the function/act specified.

The program instructions may also be loaded onto a device to produce a device implemented process such that the instructions which execute on the device provide processes for implementing the functions/acts specified.

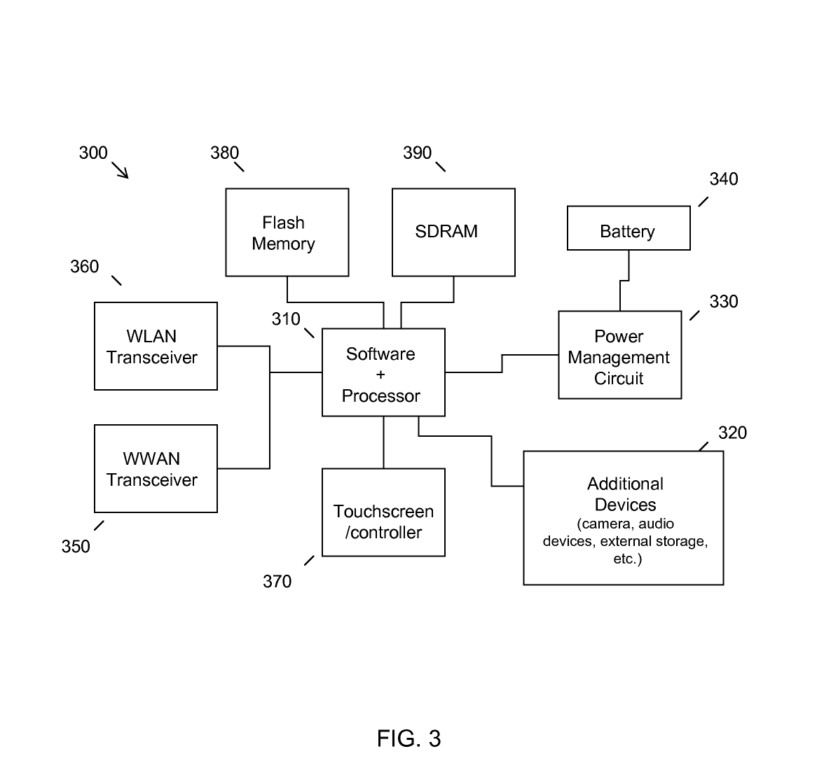

In this regard, referring to FIG. 3, one example of mobile information handling device circuitry is a system-on-chip design, commonly employed in connection with a smart phone and/or tablet circuitry 300. An example includes an ARM based system (system on a chip) design (although other processor architectures may be employed, for example x86), with software and processor(s) combined in a single chip 310. Internal busses and the like depend on different vendors, but essentially all the peripheral devices (320) may attach to a single chip 310, including audio devices such as peripheral devices connecting to the device 300 via an audio jack and used as a musical source 110. In contrast to the circuitry employed in more conventional lap top or desktop computers, which may also be utilized in an embodiment, the mobile information handling device circuitry 300 combines the processor, memory control, and I/O controller hub all into a single chip 310. Also, ARM based systems 300 do not typically use SATA or PCI or LPC. Common interfaces for example include SDIO and I2C. There are power management chip(s) 330, which manage power as supplied for example via a rechargeable battery 340, which may be recharged by a connection to a power source (not shown), and in at least one design, a single chip, such as 310, is used to supply BIOS like functionality and DRAM memory.

ARM based systems 300 typically include one or more of a WWAN transceiver 350 and a WLAN transceiver 360 for connecting to various networks, such as telecommunications networks and wireless base stations. Commonly, an ARM based system 300 will include a touchscreen 370 for data input and display. ARM based systems 300 also typically include various memory devices, for example flash memory 380 and SDRAM 390.

Thus, FIG. 3 illustrates one example of device circuitry that may be utilized in connection with audio analysis as described herein. In one embodiment, an audio analysis application that includes the musical analysis capabilities described herein may be downloaded to a device such as described in connection with FIG. 3. Thus, an embodiment provides a low-cost mechanism of recognizing musical notes played on peripheral instruments without using proprietary connections. Such an arrangement allows a device, such as illustrated in FIG. 3, to use software to analyze the audio input, for example via microphone or standard audio jack, from a peripheral musical instrument (for example, a piano, a guitar, et cetera) and identify the note or combination of notes (“note unit”) played in near real-time. An embodiment thus also allows for visual feedback to be provided to the user for educational and/or entertainment purposes. This is in stark contrast to having the peripheral musical instruments or devices be connected with proprietary connectors that work on a specific computing device and send digital note data or other signal data. Thus, an embodiment leverages standard audio input connections (for example, standard audio jacks or otherwise not be connected at all, that is, with sound picked up by a microphone of the mobile device). An embodiment therefore may work in combination with a wide range of devices. This also reduces cost by eliminating the need for a special connector and fees/technology associated with the specialized device(s) or component(s).

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments have been described herein, it is to be understood that the embodiments are not limited to those precise embodiments, and that various other changes and modifications may be affected therein by one skilled in the art without departing from the scope or spirit of the disclosure.

What is claimed is:

1. A method, comprising:
receiving an analog note unit at an information handling device;
storing note unit information corresponding to the analog note unit in a memory device of the information handling device;
identifying the analog note unit input using the note unit information; and
providing a result output to a user responsive to identifying the analog note unit.

2. The method of claim 1, wherein the analog note unit is received via a line-in jack of the information handling device.

3. The method of claim 1, further comprising, responsive to identifying the analog note unit, comparing the analog note unit to an expected note unit.

4. The method of claim 3, wherein providing a result output further comprises:
providing an indication of whether the analog note unit matches the expected note unit.

5. The method of claim 3, wherein providing a result output further comprises:
providing a visual indication of key placement on an instrument corresponding to the identified analog note unit; and
providing a visual indication of expected key placement on the instrument for producing the expected note unit.

6. The method of claim 1, wherein the analog note unit comprises two or more analog notes.

7. The method of claim 1, further comprising:
receiving a plurality of analog note units at the information handling device;
storing note unit information corresponding to the plurality of analog note units in a memory device of the information handling device;
identifying the plurality of analog note units input using the note unit information; and
providing a result output to a user responsive to identifying the plurality of analog note units.

8. The method of claim 7, wherein identifying a plurality of analog note units further comprises determining note unit spacing information.

9. The method of claim 8, wherein providing a result output to a user responsive to identifying the plurality of analog note units comprises providing output regarding the spacing of the analog note units with respect to spacing of expected analog note units.

10. The method of claim 1, wherein providing a result output to a user further comprises providing one or more corrective suggestions.

11. The method of claim 1, wherein providing a result output to a user further comprises transcribing the musical note unit.

12. A system comprising:
one or more processors; and
a memory operatively coupled to the one or more processors that stores instructions executable by the one or more processors to perform acts comprising:
receiving an analog note unit;
storing note unit information corresponding to the analog note unit;
identifying the analog note unit input using the note unit information; and
providing a result output to a user responsive to identifying the analog note unit.

13. The system of claim 11, wherein the acts further comprise, responsive to identifying the analog note unit, comparing the analog note unit to an expected note unit.

14. The system of claim 13, wherein providing a result output further comprises:
providing an indication of whether the analog note unit matches the expected note unit.

15. The system of claim 13, wherein providing a result output further comprises:
providing a visual indication of key placement on an instrument corresponding to the identified analog note unit; and
providing a visual indication of expected key placement on the instrument for producing the expected note unit.

16. The system of claim 11, wherein the analog note unit comprises two or more analog notes.

17. The system of claim 12, wherein the acts further comprise:
receiving a plurality of analog note units;
storing note unit information corresponding to the plurality of analog note units;
identifying the plurality of analog note units input using the note unit information; and
providing a result output to a user responsive to identifying the plurality of analog note units.

18. The system of claim 17, wherein identifying a plurality of analog note units further comprises determining note unit spacing information.

19. The system of claim 18, wherein providing a result output to a user responsive to identifying the plurality of analog note units comprises providing output regarding the spacing of the analog note units with respect to spacing of expected analog note units.

20. The system of claim 12, wherein providing a result output to a user further comprises transcribing the musical note unit.

21. A program product, comprising:
a storage medium having computer program code embodied therewith, the computer program code comprising:
computer program code configured to receive an analog note unit input to an information handling device;
computer program code configured to store note unit information corresponding to the analog note unit in a memory device of the information handling device;
computer program code configured to identify the analog note unit input using the note unit information; and
computer program code configured to provide a result output to a user responsive to identifying the analog note unit.
